(19) United States
(12) Patent Application Publication
(10) Pub. No.: US 2012/0187069 A1
(43) Pub. Date: Jul. 26, 2012

(54) COMPACT SPHERICAL BOTTLE WITH FLAT SIDES

(76) Inventors: Ivan F. Harris, Ypsilanti, MI (US); Bradley S. Philip, Tecumseh, MI (US); Bradley Wilson, Manchester, MI (US)

(21) Appl. No.: 13/354,187

(22) Filed: Jan. 19, 2012

Related U.S. Application Data
(60) Provisional application No. 61/435,649, filed on Jan. 24, 2011.

(51) Int. Cl. B65D 23/00; B29C 49/00; B65D 1/02

(52) U.S. Cl. 215/44; 215/382; 215/381; 215/376; 264/523

(57) ABSTRACT

A plastic container with a longitudinal axis includes a neck region with an opening into the container. The container also includes a base region that closes off the container and a sidewall continuously extending from the neck region to the base region. The sidewall includes a rounded portion and at least one panel. The rounded portion lies substantially on an imaginary rounded object that is three dimensional and that is entirely rounded. The panel lies within an imaginary plane that intersects the imaginary rounded object.

### CROSS-REFERENCE TO RELATED APPLICATION

This application claims the benefit of U.S. Provisional Application No. 61/435,649, filed on Jan. 24, 2011. The entire disclosure of the above application is incorporated herein by reference.

### FIELD

The present disclosure relates to a bottle and, more particularly relates to a compact spherical bottle with sides that are substantially flat.

### BACKGROUND

This section provides background information related to the present disclosure which is not necessarily prior art.

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-30%.

After being hot-filled, the heat-set containers may be capped and allowed to reside at generally the filling temperature for approximately five (5) minutes at which point the container, along with the product, is then actively cooled prior to transferring to labeling, packaging, and shipping operations. The cooling reduces the volume of the liquid in the container. This product shrinkage phenomenon results in the creation of a vacuum within the container. Generally, vacuum pressures within the container range from 1-380 mm Hg less than atmospheric pressure (i.e., 759 mm Hg-380 mm Hg). If not controlled or otherwise accommodated, these vacuum pressures result in deformation of the container, which leads to either an aesthetically unacceptable container or one that is unstable. Hot-fillable plastic containers usually provide sufficient flexure to compensate for the changes of pressure and temperature, while maintaining structural integrity and aesthetic appearance. Typically, the industry accommodates vacuum related pressures with sidewall structures or vacuum panels formed within the sidewall of the container. Such vacuum panels generally distort inwardly under vacuum pressures in a controlled manner to eliminate undesirable deformation.

### SUMMARY

This section provides a general summary of the disclosure, and is not a comprehensive disclosure of its full scope or all of its features.

A plastic container with a longitudinal axis is disclosed that includes a neck region with an opening into the container. The container also includes a base region that closes off the container and a sidewall continuously extending from the neck region to the base region. The sidewall includes a rounded portion and at least one panel. The rounded portion lies substantially on an imaginary rounded object that is three dimensional and that is entirely rounded. The panel lies within an imaginary plane that intersects the imaginary rounded object.

A method of forming a plastic container with a neck region having an opening into the container is also disclosed. The method includes blow molding a base region that closes off the container. The method further includes blow molding a sidewall that continuously extends from the neck region to the base region. The sidewall includes a rounded portion and at least one panel. The rounded portion lies substantially on an imaginary rounded object that is three dimensional and that is entirely rounded. The at least one panel lies within an imaginary plane that intersects the imaginary rounded object.

Still further, a plastic container with a longitudinal axis is disclosed. The container includes a neck region with an opening into the container, and the neck region includes a threaded finish. The container also includes a base region that closes off the container. The base region includes a central base portion operable to support the container upright on a surface. The central base portion includes a pushup that is recessed inward along the longitudinal axis. Moreover, the container includes a sidewall continuously extending from the neck region to the base region. The sidewall includes a rounded portion and a plurality of panels. The rounded portion lies substantially on an imaginary sphere. The imaginary sphere has a center that lies on the longitudinal axis. The imaginary sphere has a radius measured from the center. The plurality of panels lie substantially within respective imaginary planes that intersect the imaginary sphere. The imaginary spheres are spaced apart at a distance from the center. The distance is less than the radius. The plurality of panels include a first pair of panels that are parallel to each other and disposed on opposite sides of the longitudinal axis. The plurality of panels also includes a second pair of panels that are parallel to each other and disposed on opposite sides of the longitudinal axis. The first pair of panels are perpendicular to the second pair of panels. Each of the plurality of panels is flexible to flex relative to the longitudinal axis depending on the pressure within the container. The container further includes a plurality of convex transitions defined from the rounded portion to a respective one of the plurality of panels.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of the container according to various exemplary embodiments of the present disclosure;

FIG. 2 is a bottom perspective view of the container of FIG. 1;

FIG. 3 is a front view of the container of FIG. 1;

FIG. 4 is a side view of the container of FIG. 1;

FIG. 5 is a bottom view of the container of FIG. 1; and

FIG. 6 is a sectional view of a preform used to form the container of FIG. 1.

Corresponding reference numerals indicate corresponding parts throughout the several views of the drawings.

### DETAILED DESCRIPTION

Example embodiments will now be described more fully with reference to the accompanying drawings.

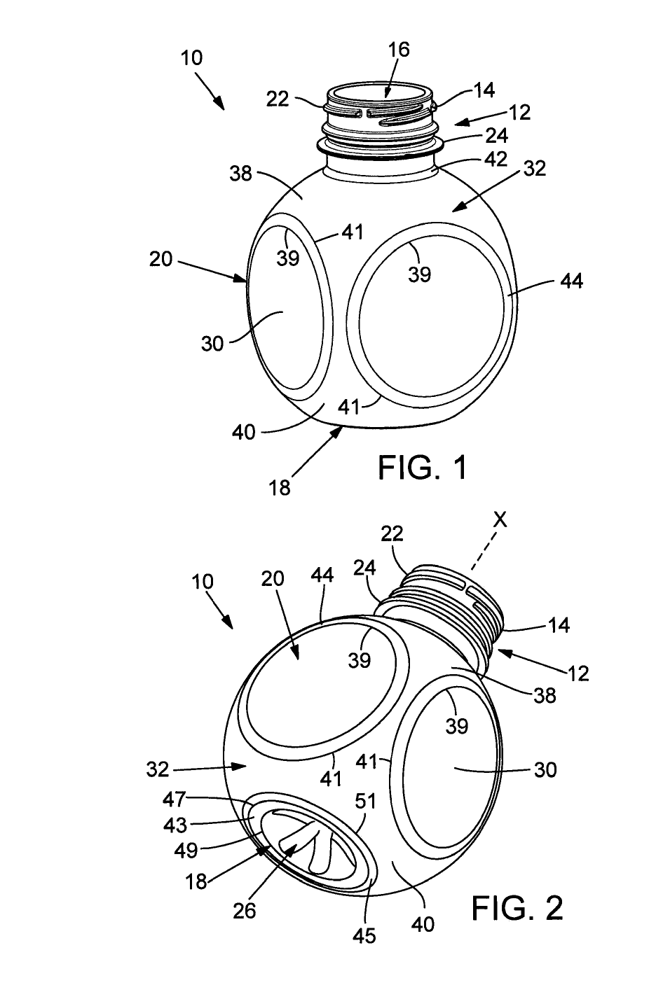

Referring now to FIGS. 1-5, exemplary embodiments of a container 10 are illustrated according to various teachings of the present disclosure. The container 10 can be made of plastic, such as polyethylene terephthalate (PET), and the container 10 can be made in a molding process, such as a blow molding process. More specifically, the container 10 can be made via extrusion blow molding, injection blow molding stretch blow molding, or any other suitable blow molding process. Also, the container 10 can be a single, integral, monolithic object. The container 10 can have a straight, longitudinal axis X.

Generally, the container 10 can include a neck region 12 with a finish 14 and an opening 16 (FIG. 1) into the container 10. The container 10 can also include a base region 18 that is opposite the neck region 12 and that closes off the container 10. Moreover, the container 10 can include a sidewall 20 that continuously extends from the neck region 12 to the base region 18.

The neck region 12 of the container 10 can be substantially cylindrical. The opening 16 can be substantially circular and can extend through the neck region 12 at substantially a constant diameter. The finish 14 can include at least one thread 22 that extends helically along the neck region 12. The neck region 12 can also include a handling member 24. The handling member 24 can be annular in shape and can encircle the neck region 12 between the side wall 20 and the thread 22. The handling member 24 can also project radially outward from the neck region 12, substantially perpendicularly away from the longitudinal axis X of the container 10. The handling member 24 can be used to support the container 10 during manufacturing. For instance, the handling member 24 can hang from manufacturing tooling (not shown), conveyors, filling machines, or other devices to support the container 10 during various processes.

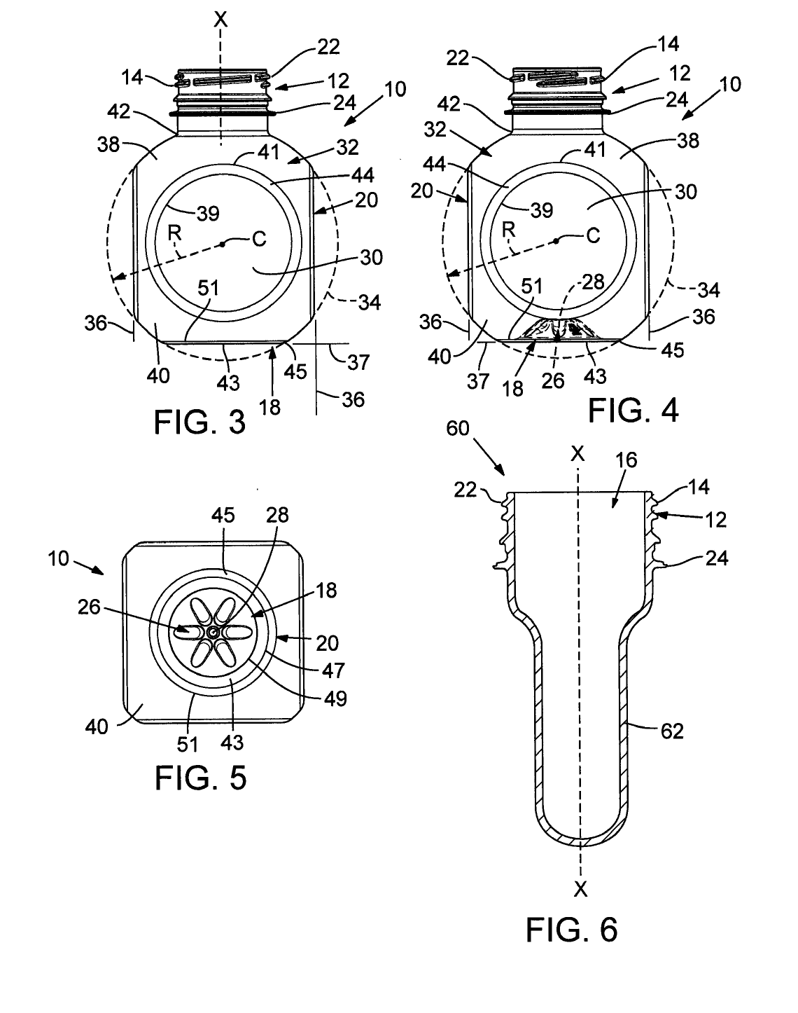

The sidewall 20 can be substantially rounded, but for one or more substantially flat panels 30. More specifically, the sidewall 20 can include a substantially rounded portion 32 and one or more (e.g., four) substantially flat panels 30. The rounded portion 32 can lie substantially on (i.e., can lie substantially within) an imaginary rounded object, such as a sphere 34 (shown in broken lines in FIG. 3). A center C of the sphere 34 can be located on the longitudinal axis X. The sphere 34 can have any suitable radius R, measured from the center C of the sphere 34.

It will be appreciated that the rounded portion 32 can lie on a three dimensional, entirely rounded object other than a sphere 34. For instance, the rounded portion 32 can lie on an imaginary three dimensional oval (i.e., an ovoid), a three dimensional ellipse (i.e., a prolate spheroid or an oblate spheroid), etc.

The rounded portion 32 can include an upper portion 38 that is adjacent the neck region 12 and a lower portion 40 that is adjacent the base region 18. The upper portion 38 can lie substantially on an upper half or hemisphere of the sphere 34, and the lower portion 40 can lie substantially on a lower symmetric half or hemisphere of the sphere 34. The upper portion 38 can extend about the axis X, above and between the panels 30, and the lower portion 40 can extend about the axis X and below and between the panels 30. Also, the upper and lower portions 38, 40 can extend along the axis X, between the panels 30 to be joined continuously together.

In the embodiments illustrated, the rounded portion 32 has a smooth inner and outer surface. However, in other embodiments, the inner and/or outer surface of the rounded portion 32 can be textured (e.g., with gnarled surfaces, wavy surfaces, ribs, small bumps, dimples, etc.).

Moreover, as shown in FIGS. 1, 3, and 4, the container 10 can include an upper transition 42 defined between the rounded portion 32 and the neck region 12. The upper transition 42 can be rounded to have a concave curvature (when viewed from outside the container 10). The upper transition 42 can have any suitable radius.

The flat panels 30 will now be discussed. The flat panels 30 can each lie within a respective plane 36 (FIG. 3) that intersects the imaginary sphere 34. As shown, the plane 36 can intersect the sphere 34 so as to divide a spherical cap from the sphere 34. The plane 36 can be parallel to the longitudinal axis X and can be spaced away from the center C of the sphere 34 at a distance less than the radius R. As such, each panel 30 can include a substantially circular edge 39 that lies within the respective plane 36.

FIGS. 3 and 4 show the sphere 34 projected onto a two dimensional surface. As such, the imaginary sphere 34 is a circle in the embodiments of FIGS. 3 and 4. Also, the planes 36 can each be a secant line to that circle as shown in FIGS. 3 and 4. It will be appreciated that, although the panels 30 (and the respective planes 36) are shown substantially parallel to the longitudinal axis X, the panels 30 (and respective planes 36) could be disposed at any suitable angle relative to the axis X.

The container 10 can include any suitable number of flat panels 30. In the embodiments illustrated, for instance, the container 10 can include four flat panels 30 that are arranged in two pairs. The panels 30 of each pair can be parallel to each other and located on opposite sides of the axis X. Also, the first pair of panels 30 can be substantially perpendicular to the second pair of panels 30.

Also, the container 10 can have a plurality of sidewall transitions 44. The transitions 44 can be defined from the rounded portion to a respective one of the panels 30. More specifically, the transitions 44 can be rounded to have a convex curvature (when viewed from outside the container 10) and can be defined from the circular edge 39 of the respective panel 30 and a respective circular edge 41 of the rounded portion 32. The transitions 44 can have any suitable radius. Thus, the transitions 44 can be three-dimensionally curved.

Also, as shown in FIGS. 2 and 5, the base region 18 can include a central base portion 43. The central base portion 43 can be lie within a plane 37 (FIGS. 3 and 4) that is perpendicular to the longitudinal axis X. Thus, the central base portion 43 can be operable to support the container upright on a surface (e.g., a tabletop, a pallet, etc.). The central base portion 43 can be defined between a substantially circular inner edge 49 and a substantially circular outer edge 47. The central base portion 43 can also include a central push-up portion 26 that is recessed inward along the axis X and that is circumscribed by the inner edge 49. The push-up portion 26 can have any suitable shape. For instance, the push-up portion 26 can include a plurality of three-dimensionally contoured surfaces, for instance, arranged in a six-pointed star or other shape. A plateau 28 (FIG. 4) of the push-up portion 26 can be substantially centered on the axis X. In additional embodiments, the central base portion 43 is completely flat (i.e., without the push-up portion 26) such that the central base portion 43 lies completely within the plane 37 within the outer edge 47.

Still further, the container 10 can include a base transition 45 defined from the rounded portion to the central base portion 43. In the embodiments illustrated, the base transition 45 can be defined between a substantially circular upper edge 51 and the outer edge 47 of the central base portion 43. The base transition 45 can be rounded to have a concave curvature (when viewed from outside the container 10). The base transition 45 can have any suitable radius.

It will be appreciated that the container 10 can be filled with any suitable substance, including solids, liquids, and gases. In some embodiments, the container 10 can be filled with a heated substance, and upon cooling a vacuum can be created within the container 10. To ensure that the container 10 can withstand such vacuum pressure, the panels 30 can be flexible to flex inward and/or outward relative to the longitudinal axis X. The amount of flexure or displacement of the panels 30 relative to the axis X can depend on the pressure within the container 10. In some embodiments, the base region 18 can also be flexible to flex upwards and/or downward along the axis X in response to pressure changes within the container 10. Thus, the panels 30 and/or the base region 18 can act as vacuum panels for the container 10.

Furthermore, one or both of the upper and lower portions 38, 40 of the rounded portion 32 can be substantially rigid under normal internal pressure changes such that only the panels 30 and/or the base region 18 flexes due to the internal pressure changes. Accordingly, the container 10 can maintain its generally spherical shape and associated aesthetic appeal and its structural integrity despite changes in pressure within the container 10.

In some embodiments, the panels 30 can each have substantially the same area. In other embodiments, the panels 30 can differ in area. In the latter case, a larger panel 30 can be more flexible and more deflectable than a smaller panel 30. Accordingly, the panels 30 can be sized such that the container 10 flexes in a predetermined, controlled manner. In other words, the flexure of the container 10 under vacuum can be controlled by the sizing of the panels 30.

Moreover, the panels 30 can be planar and substantially perpendicular to the axis X at some container pressures, and these panels 30 can flex inwardly (concavely) or outwardly (convexly), depending on pressure changes within the container 10. Also, in some embodiments, the panels 30 can be biased inwardly (concavely) or biased outwardly (convexly) so that the flexure of the panels 30 can be further controlled.

The container 10 can have a total volume V. Also, the surface area of one panel 30 (not including the sidewall transitions 44) can be designated as SA_{flat}. The area of the base region 18 (calculated as the two-dimensional area within the edge 47) can be designated as SA_{base}. Also, the surface area of the rounded portion 32 (not including the sidewall transitions 44 or the transition 42) can be designated as SAₛₚₕₑᵣₑ. Moreover, the total surface area of the container 10 below the neck region 12 can be designated as SAₜₒₜₐₗ.

Thus, in some embodiments, a Vacuum Absorbing Area of the container 10 (i.e., surface area of the container 10 below neck region 12 that absorbs a vacuum therein) can be calculated according to:

Vacuum Absorbing Area=(N×SA_{flat})+SA_{base}

where N is the number of panels 30 included on the container 10 (e.g., N=4 for the embodiments illustrated) and assuming that both the panels 30 and base region 18 absorbs the vacuum. Also, in some embodiments, a Total Rigid Area of the container 10 (i.e., surface area of the container 10 below neck region 12 that is rigid under vacuum) can be calculated according to:

Total Rigid Area=SAₜₒₜₐₗ−(N×SA_{flat})−SA_{base}

Moreover, in some embodiments, a Vacuum Area of the container 10 (i.e., total surface area of the panels 30) can be calculated according to:

Vacuum Area=N×SA_{flat}

In some embodiments, the Total Rigid Area can be between approximately twenty percent (20%) and thirty percent (30%) larger than the Vacuum Absorbing Area. Still further, in some embodiments, the surface area of the rounded portion 32, SAₛₚₕₑᵣₑ, can be between approximately five percent (5%) and fifteen percent (15%) larger than the Vacuum Absorbing Area. Also, in some embodiments, the ratio of the total volume V of the container 10 to the Vacuum Area can be between approximately 2.5:1 and 3.5:1. For instance, this ratio of the total volume V to the Vacuum Area can be approximately 3:1.

In some embodiments, SAₜₒₜₐₗ is approximately 182.90 cm². Also, SA_{flat} can be approximately 16.44 cm² such that the Vacuum Area is approximately 65.76 cm². Moreover, SA_{base} can be approximately 10.84 cm². Additionally, SAₛₚₕₑᵣₑ can be approximately 68.72 cm². Thus, using these dimensions, Vacuum Absorbing Area can equal approximately 76.59 cm², and Total Rigid Area can equal approximately 106.31 cm² such that the Total Rigid Area is approximately 28% larger than the Vacuum Absorbing Area. Also, using these dimensions, Vacuum Area can equal approximately 65.75 cm², and the total volume V can equal approximately 209 ml such that the ratio of the total volume V to the Vacuum Area is approximately 3:1.

Each of these dimensions, the relationship of the Total Rigid Area to the Vacuum Absorbing Area, and/or the relationship of the total volume V to the Vacuum Area can allow the container 10 to substantially retain its shape during normal use. For instance, these dimensions and dimensional relationships can allow the flat panels 30 and/or base region 18 to flex due to a vacuum within the container 10 without flexure of the other (rigid) regions. Also, because of these dimensions and dimensional relationships, residual vacuum stresses can be relatively low.

The container 10 can have other characteristics. For instance, the wall thickness of the container 10 can range between 0.008 inches and 0.028 inches.

As mentioned above, the container 10 can be formed via molding processes, such as blow molding processes. As such, a preform 60 (i.e., parison) as shown in FIG. 6 can be formed, which includes the neck region 12 and finish 14 included thereon. The preform 60 can also include a lower portion 62. Once introduced into a mold (not shown), air or other fluid can be introduced into the preform 60 to force the lower portion 62 toward the internal surfaces of the mold, and the base region 18 and sidewall 20 can be formed as discussed above. The neck region 12 and/or finish may not change significantly during the blow molding from the preform 60 to the container 10. Accordingly, the container 10 can be manufactured in an efficient manner.

Thus, the container 10 can be very aesthetically pleasing. Also, the container 10 can hold its shape, even under vacuum or other loading conditions. Additionally, the container 10 can be lightweight (e.g., approximately 12.5 grams+/−0.2 grams). Moreover, when arranged side-by-side, the flat panels 30 of different containers 10 can abut each other such that the containers 10 can be gathered together and packaged conveniently and compactly (e.g., on a pallet). Furthermore, the containers 10 can be stacked atop each other, and the containers 10 are likely to hold their shape. In addition, the partly spherical shape of the container 10 can optimize the surface area of the container 10, thus resulting in an improved shelf life through minimal oxygen transfer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A plastic container with a longitudinal axis comprising:
a neck region with an opening into the container;
a base region that closes off the container; and
a sidewall continuously extending from the neck region to the base region, the sidewall including a rounded portion and at least one panel, the rounded portion lying substantially on an imaginary rounded object that is three dimensional and that is entirely rounded, the at least one panel lying within an imaginary plane that intersects the imaginary rounded object.

2. The plastic container of claim 1, wherein the imaginary rounded object is an imaginary sphere.

3. The plastic container of claim 1, wherein the imaginary plane is parallel to the longitudinal axis.

4. The plastic container of claim 1, wherein the imaginary rounded object defines a first half and a second half, the first and second halves being symmetric to each other, wherein the rounded portion includes an upper portion and a lower portion, the upper portion being adjacent the neck region and the lower portion being adjacent the base region, the upper portion lying substantially on the first half of the imaginary rounded object, the lower portion lying substantially on a lower half of the imaginary rounded object.

5. The plastic container of claim 1, wherein the at least one panel includes a plurality of panels that lie within respective planes that are substantially perpendicular to each other.

6. The plastic container of claim 1, wherein the at least one panel includes a pair of panels that lie within respective planes that are parallel to each other and disposed on opposite sides of the longitudinal axis.

7. The plastic container of claim 6, wherein the at least one panel includes a first pair of panels that lie within respective first planes that are substantially parallel to each other and a second pair of panels that lie within respective second planes that are substantially parallel to each other, the first planes being substantially perpendicular to the second planes.

8. The plastic container of claim 1, wherein the at least one panel is a vacuum panel that is flexible to flex inward and outward relative to the longitudinal axis, depending on a pressure within the container.

9. The plastic container of claim 8, wherein the rounded portion is substantially rigid.

10. The plastic container of claim 9, wherein the container defines a Vacuum Absorbing Area and a Total Rigid Area, and wherein the Total Rigid Area is approximately twenty to thirty percent (20%-30%) larger than the Vacuum Absorbing Area.

11. The plastic container of claim 9, wherein the container defines a Vacuum Area and a Total Container Volume, and wherein a ratio of the Total Container Volume to Vacuum Area is between approximately 2.5:1 and 3.5:1.

12. The plastic container of claim 1, wherein the container defines a Vacuum Absorbing Area, and wherein a total surface area of the rounded portion is approximately five percent (5%) to fifteen percent (15%) larger than the Vacuum Absorbing Area.

13. The plastic container of claim 1, further comprising at least one convex transition defined from the rounded portion to the at least one panel.

14. The plastic container of claim 1, wherein the base region includes a central base portion operable to support the container upright on a surface and a convex base transition defined from the rounded portion to the central base portion.

15. The plastic container of claim 14, wherein the central base portion includes a pushup that is recessed inward along the longitudinal axis.

16. A method of forming a plastic container with a neck region having an opening into the container comprising:
blow molding a base region that closes off the container; and
blow molding a sidewall that continuously extends from the neck region to the base region, the sidewall including a rounded portion and at least one panel, the rounded portion lying substantially on an imaginary rounded object that is three dimensional and that is entirely rounded, the at least one panel lying within an imaginary plane that intersects the imaginary rounded object.

17. The method of claim 16, wherein blow molding the base and blow molding the sidewall include blow molding the base and the sidewall from a preform.

18. The method of claim 16, wherein blow molding the sidewall includes blow molding the sidewall to include a first pair of panels that lie within respective first planes that are substantially parallel to each other and disposed on opposite sides of the longitudinal axis and to include a second pair of panels that lie within respective second planes that are substantially parallel to each other and disposed on opposite sides of the longitudinal axis, the first planes being substantially perpendicular to the second planes.

19. The method of claim 16, wherein the container defines a Vacuum Area and a Total Container Volume, and wherein a ratio of the Total Container Volume to Vacuum Area is between approximately 2.5:1 and 3.5:1.

20. A plastic container with a longitudinal axis comprising:
a neck region with an opening into the container, the neck region including a threaded finish;
a base region that closes off the container, the base region including central base portion operable to support the container upright on a surface, the central base portion including a pushup that is recessed inward along the longitudinal axis;
a sidewall continuously extending from the neck region to the base region, the sidewall including a rounded portion and a plurality of panels, the rounded portion lying substantially on an imaginary sphere, the imaginary sphere having a center that lies on the longitudinal axis, the imaginary sphere having a radius measured from the center, the plurality of panels lying substantially within respective imaginary planes that intersect the imaginary sphere, the imaginary spheres being spaced apart at a distance from the center, the distance being less than the radius, the plurality of panels including a first pair of panels that are parallel to each other and disposed on opposite sides of the longitudinal axis, the plurality of panels also including a second pair of panels that are parallel to each other and disposed on opposite sides of the longitudinal axis, the first pair of panels being perpendicular to the second pair of panels, each of the plurality of panels being flexible to flex relative to the longitudinal axis depending on the pressure within the container; and
a plurality of convex transitions defined from the rounded portion to a respective one of the plurality of panels.
